(19) United States
(12) Patent Application Publication
(10) Pub. No.: US 2021/0003938 A1
(43) Pub. Date: Jan. 7, 2021

(54) DEVELOPING DEVICE AND IMAGE FORMING APPARATUS

(71) Applicant: Konica Minolta Inc., Tokyo (JP)

(72) Inventors: Futoshi OKAZAKI, Toyokawa-shi (JP); Yasuyuki INADA, Toyohashi-shi (JP); Noriyuki KINPARA, Toyohashi-shi (JP); Hideaki IKEDA, Toyokawa-shi (JP); Takeru KINOSHITA, Toyokawa-shi (JP); Junji MURAKAWA, Toyokawa-shi (JP)

(21) Appl. No.: 16/903,725

(22) Filed: Jun. 17, 2020

(30) Foreign Application Priority Data
Jul. 1, 2019 (JP) 2019-122803

(51) Int. Cl. G03G 15/08; G03G 15/09

(52) U.S. Cl. CPC G03G 15/0818; G03G 2215/0609; G03G 15/0928

(57) ABSTRACT

A developing device, includes: a developing sleeve supported rotatably, the developing sleeve having a hollow, substantially cylindrical shape; a magnet part having a substantially columnar shape, the magnet part having magnetic poles disposed side by side around an axis, the magnet part being disposed substantially coaxially with the developing sleeve inside the developing sleeve; a rod fastened to the magnet part, the rod extending from one end in an extending direction of the axis of the magnet part, the rod being pulled out from one axial end of the developing sleeve; and a holder attached to a portion of the rod pulled out from the developing sleeve, the holder being fastened to a fastening target, the holder maintaining the rod, the holder regulating rotation of the magnet part, wherein adjustment of the holder in fastening position enables disposition and holding of the rod at an optional position.

The entire disclosure of Japanese patent Application No. 2019-122803, filed on Jul. 1, 2019, is incorporated herein by reference in its entirety.

### BACKGROUND

### Technological Field

The present invention relates to a developing device that supplies a developer to an image carrier, and an image forming apparatus such as a copier, a printer, and, a facsimile including the developing device at an image former that forms an image by using an electrophotographic method, regardless of a type such as color and monochrome.

### Description of the Related Art

Generally, an electrophotographic image forming apparatus includes a developing roller serving as a developer carrier provided in a developing device, and the developer is supplied to a photoconductor serving as an image carrier by the developing roller. The developing roller includes: a developing sleeve supported rotatably, the developing sleeve having a hollow, substantially cylindrical shape; and a magnet part having a substantially columnar shape, the magnet part having a plurality of magnetic poles disposed side by side around the axis, the magnet part being disposed inside the developing sleeve.

At the time of assembly, the magnet part needs adjustment in provision angle such that the provision angle agrees with a predetermined regulation angle (i.e., positioning is made circumferentially) and needs to be fastened such that rotation of the magnet part is regulated. Therefore, normally, a rod provided on the magnet part is pulled out from one axial end of the developing sleeve, and the portion of the rod pulled out from the developing sleeve is unrotatably fastened to a fastening target including a housing of the developing device and the like. As a result, the angle of the magnet part is adjusted in angle and the rotation thereof is regulated. Here, in order to fasten the rod to the fastening target, a holder formed of a metal plate-like member is used generally.

For example, JP 2007-316456 A discloses a developing device having the above configuration. The developing device disclosed in JP 2007-316456 A includes a holder formed of a metal plate-like member bent in a predetermined shape, part of the holder is press inserted into a groove and fastened to the groove provided on one end face of a rod extending from a magnet part, and the holder is fastened to a housing with a screw. With this arrangement, the angle of the magnet part is adjusted and rotation thereof is regulated.

Normally, a developing device includes a regulation member disposed opposite to the outer circumferential face of the developing sleeve, in order to adjust the layer thickness of a developer adhering to the front face of the developing sleeve due to magnetic attraction by a magnet part. The regulation member generally includes a magnetic body. Thus, the magnet part warps toward the regulation member side due to magnetic attraction force by the magnet part. In addition, the magnetic attraction force acts on carrier contained in the developer adhering to the developing sleeve, so that the magnet part warps. Accompanying with the warp of the magnet part, a rod warps inevitably.

Further, the magnet part and the rod are manufactured by attaching a magnet to a metal shaft member, or by integrally fastening a magnet to a metal shaft member by resin molding. Alternatively, the magnet part and the rod are manufactured by externally inserting a metal shaft member into a magnet formed by injection molding using a composite material containing a magnetic powder and a resin material. Thus, in some cases, a considerable degree of variation in dimensional accuracy occurs depending on the finished quality of the magnet part and the rod.

Here, a magnet part fastening method conventionally known such as disclosed in JP 2007-316456 A is a method of positioning a rod by using a holder formed of a metal plate-like member described above such that the axis of the rod agrees with the predetermined nominal center position and by fastening the rod such that rotation thereof is regulated. Therefore, in a case where the fastening method is adopted, any of the warps occurred at the magnet part and the rod and the variation in dimension occurred due to the finished quality of the magnet part and the rod described above are not absorbed, and the rod is forcibly disposed at the nominal center position. As a result, the forcible disposition may cause unnatural warps on the magnet part and the rod of which the warps are natural.

These unnatural warps on the magnet part and the rod act as a stress on a bearing disposed between the rod and the developing sleeve. Therefore, this stress acts as a rotational resistance against rotation of the developing sleeve and hinders smooth rotation of the developing sleeve. As a result, the hindrance may cause disturbance or noise to occur in a formed image.

### SUMMARY

Therefore, the present invention has been made in view of the above-described disadvantages, and an object of the present invention is to provide a developing device in which smooth rotation of a developing sleeve is achieved, and an image forming apparatus including the developing device.

To achieve the abovementioned object, according to an aspect of the present invention, a developing device reflecting one aspect of the present invention comprises: a developing sleeve supported rotatably, the developing sleeve having a hollow, substantially cylindrical shape; a magnet part having a substantially columnar shape, the magnet part having a plurality of magnetic poles disposed side by side around an axis, the magnet part being disposed substantially coaxially with the developing sleeve inside the developing sleeve; a rod fastened to the magnet part, the rod extending from one end in an extending direction of the axis of the magnet part, the rod being pulled out from one axial end of the developing sleeve; and a holder attached to a portion of the rod pulled out from the developing sleeve, the holder being fastened to a fastening target, the holder maintaining the rod, the holder regulating rotation of the magnet part, wherein adjustment of the holder in fastening position to the fastening target enables disposition and holding of the rod at an optional position within a predetermined range in an in-plane direction of a plane orthogonal to the axis, and in a case where a state before the holder is attached to the rod and fastened to the fastening target is defined as a non-fastened state, after the rod is rotated such that a provision angle of the rod in a circumferential direction of the rod in the non-fastened state agrees with a predetermined regulation angle, the holder is attached to the rod and fastened to the fastening target such that a provision position of the rod at which the provision angle agrees with the regulation angle is maintained as the provision position is.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic view of an image forming apparatus according to an embodiment;

FIG. 2 is a schematic cross-sectional view of a developing device according to the embodiment;

FIG. 3 is a schematic cross-sectional view illustrating a configuration of a developing roller illustrated in FIG. 2 and an assembly structure of the developing roller to a housing;

FIGS. 4A and 4B are schematic views for explaining the concept of a magnet part fastening method according to a conventional example;

FIG. 5 is a view illustrating an example of a provision position of a rod in a non-fastened state in a case where the magnet part fastening method according to the conventional example is adopted;

FIG. 6 is a view illustrating a shape of a holder according to the conventional example;

FIG. 7 is a view illustrating a fastened state of the rod according to the conventional example;

FIGS. 8A and 8B are schematic views for explaining the concept of a magnet part fastening method according to a first configuration example;

FIG. 9 is a view illustrating an example of a provision position of a rod in a non-fastened state in a case where the magnet part fastening method according to the first configuration example is adopted;

FIGS. 10A and 10B are views illustrating a shape of a holder according to the first configuration example;

FIG. 11 is a view illustrating a temporarily fastened state of the rod according to the first configuration example;

FIG. 12 is a view illustrating a fastened state of the rod according to the first configuration example;

FIG. 13 is a view illustrating an example of a provision position of a rod in a non-fastened state in a case where a magnet part fastening method according to a second configuration example is adopted;

FIG. 14 is a view illustrating a shape of a holder according to the second configuration example; and

FIG. 15 is a view illustrating a fastened state of a rod according to the second configuration example.

### DETAILED DESCRIPTION OF EMBODIMENTS

Hereinafter, one or more embodiments of the present invention will be described in detail with reference to the drawings. However, the scope of the invention is not limited to the disclosed embodiments. In the embodiment described below, as an image forming apparatus and a developing device to which the present invention is applied, a so-called tandem color printer adopting an electrophotographic method and a developing device included in the tandem color printer will be described exemplarily. Note that in the embodiment described below, the same or common portions are denoted by the same reference signs in the drawings, and the description thereof will not be repeated.

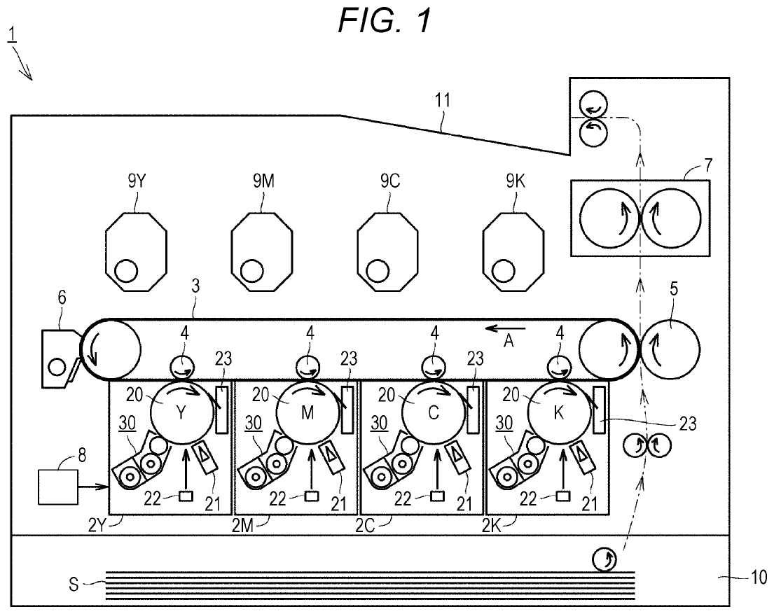

FIG. 1 is a schematic view of an image forming apparatus according to the embodiment. First, an image forming apparatus 1 according to the present embodiment will be described with reference to FIG. 1.

As illustrated in FIG. 1, the image forming apparatus 1 includes: image forming units 2Y, 2M, 2C, and 2K; an intermediate transfer belt 3; transfers; a secondary transfer roller 5; a belt cleaning device 6; a fixing device 7; a control device 8; and a cassette 10.

The image forming unit 2Y receives a supply of toner from a toner bottle 9Y and forms a yellow (Y) toner image. The image forming unit 2M receives a supply of toner from a toner bottle 9M and forms a magenta (M) toner image. The image forming unit 2C receives a supply of toner from a toner bottle 9C and forms a cyan (C) toner image. The image forming unit 2K receives a supply of toner from a toner bottle 9K and forms a black (K) toner image.

The image forming units 2Y, 2M, 2C, and 2K are disposed in this order along the rotation direction of the intermediate transfer belt 3 (direction of an arrow A illustrated in FIG. 1). Each of the image forming units 2Y, 2M, 2C, and 2K includes a photoconductor 20, a charger 21, an exposure device 22, a cleaning device 23, and a developing device 30 according to the present embodiment.

The photoconductor 20 serves as an image carrier that carries a toner image. As an example, the photoconductor 20 has a drum shape. On the front face of the photoconductor 20, a photosensitive layer is formed. The charger 21 uniformly charges the front face of the photoconductor 20. The exposure device 22 irradiates the photoconductor 20 with a laser beam in response to a control signal from the control device 8, and exposes the front face of the photoconductor 20 in accordance with a designated image pattern. As a result, an electrostatic latent image corresponding to an input image is formed on the photoconductor 20. The electrostatic latent image formed on the photoconductor 20 is developed as a toner image by the developing device 30. Details of the developing device 30 will be described later.

Each transferer includes a primary transfer roller 4. The photoconductor 20 and the intermediate transfer belt 3 are in contact with each other at a portion where the primary transfer roller 4 is provided. The toner image developed on the photoconductor 20 is transferred onto the intermediate transfer belt 3 by transfer bias applied to the contact portion. Each primary transfer roller 4 transfers the toner image developed by the developing device 30, onto a recording medium. At this time, the yellow (Y) toner image, the magenta (M) toner image, the cyan (C) toner image, and the black (K) toner image are sequentially superimposed and transferred onto the intermediate transfer belt 3. As a result, a color toner image is formed on the intermediate transfer belt 3.

The cleaning device 23 includes a cleaning blade. The cleaning blade comes into press-contact with the photoconductor 20, and collects toner remaining after the transfer of the toner image, on the front face of the photoconductor 20.

Each sheet S as a recording medium is set in the cassette 10. The sheets S are sent one by one from the cassette 10 to the secondary transfer roller 5. The secondary transfer roller 5 transfers the toner image transferred on the intermediate transfer belt 3, onto the sheet S. The timing of sending and conveying the sheet S is synchronized with the position of the toner image on the intermediate transfer belt 3, so that the toner image is transferred onto a suitable position on the sheet S. Then, the sheet S is sent to the fixing device 7.

The fixing device 7 presses and heats the sheet S. As a result, the toner on the toner image is melt on the sheet S and the toner image is fixed on the sheet S. Then, the sheet S is discharged to a tray 11.

The belt cleaning device 6 includes a cleaning blade. The cleaning blade comes into press-contact with the intermediate transfer belt 3 and collects toner on the intermediate transfer belt 3, the toner remaining after the transfer of the toner image. The collected toner is conveyed by a conveyance screw and stored in a waste toner container (not illustrated).

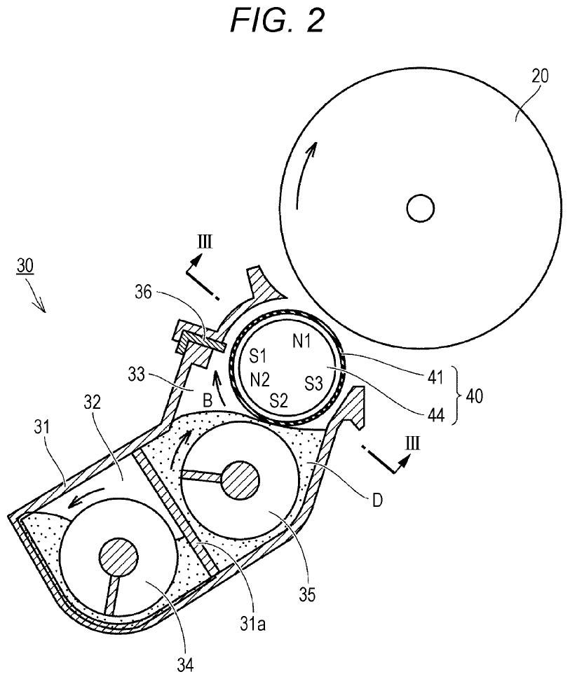

FIG. 2 is a schematic cross-sectional view of the developing device according to the present embodiment. Next, a schematic configuration and operation of the developing device 30 according to the present embodiment will be described with reference to FIG. 2.

As illustrated in FIG. 2, the developing device 30 includes a housing 31 serving as a developing container, a regulation member 36, and a developing roller 40. A partition wall 31a is provided inside the housing 31 along the axial direction of the developing roller 40. The space inside the housing 31 is partitioned into a stirring tank 32 and a supply tank 33 by the partition wall 31a. A developer D is accommodated inside the stirring tank 32 and the supply tank 33. The developer D contains toner and magnetic carrier.

A first stirring member 34 is provided inside the stirring tank 32. As the first stirring member 34 rotates, the stirring tank 32 conveys the developer D toward the supply tank 33 while stirring the developer D. A second stirring member 35 is provided inside the supply tank 33. As the second stirring member 35 rotates, the supply tank 33 conveys the developer D toward the developing roller 40 while stirring the developer D, and supplies the developer D to the developing roller 40.

The first stirring member 34 and the second stirring member 35 rotate in directions opposite to each other. As a result, the developer D circulates between the stirring tank 32 and the supply tank 33 through circulation ports (not illustrated) provided at both ends of the partition wall 31a.

The developing roller 40 includes a developing sleeve 41 and a magnet part 44, and the developing sleeve 41 is provided rotatably along the direction of an arrow B illustrated in the figure. The developing roller 40 is disposed at a predetermined distance from the outer circumferential face of the photoconductor 20, the developing roller 40 being opposite to the photoconductor 20.

The developing sleeve 41 has a hollow, substantially cylindrical shape, and carries the developer D on the outer circumferential face of the developing sleeve 41. The magnet part 44 has a substantially columnar shape, and attracts or repels the developer D by magnetism. The magnet part 44 is disposed inside the developing sleeve 41.

The magnet part 44 has a plurality of magnetic poles disposed side by side around the axis. The plurality of magnetic poles includes a pumping pole S2, a conveying pole N2, a regulating pole S1, a developing pole N1, and a peeling pole S3. The pumping pole S2, the conveying pole N2, the regulating pole S1, the developing pole N1, and the peeling pole S3 are disposed side by side in this order and spaced apart from each other at a distance along the rotation direction of the developing sleeve 41.

The regulation member 36 is disposed opposite to the developing roller 40, the regulation member 36 being disposed at a predetermined distance from the outer circumferential face of the developing sleeve 41. The regulation member 36 is located opposite to the regulating pole S1 of the plurality of magnetic poles provided on the magnet part 44 described above. The regulation member 36 is formed of a plate-like member and extends along the axial direction of the developing roller 40.

The regulation member 36 regulates the amount of the developer D carried on the outer circumferential face of the developing sleeve 41 (i.e., the layer thickness of the developer D). The regulation member 36 includes, for example, a magnetic body. In a case where the regulation member 36 includes a magnetic body as described above, a magnetic field is formed between the regulation member 36 and the developing roller 40, so that magnetic attraction force acts on the front face of the regulation member 36 Therefore, the developer D is leveled more easily, and the layer thickness of the developer D is adjusted easily.

The developer D generates static electricity by stirring and is charged. The charged developer D is attracted to the pumping pole S2 and adheres to the developing sleeve 41. The developer D adhering to the developing sleeve 41 is conveyed toward the regulating pole S1 by the conveying pole N2.

The developer D conveyed by the conveying pole N2 is leveled by the regulation member 36, and the conveyance amount of the developer D is constant. As described above, the regulating pole S1 regulates the amount of the developer D carried on the developing sleeve 41 in cooperation with the regulation member 36.

After passing the regulation member 36, the developer D is conveyed to the developing pole N1. The developer D is subjected to magnetic force from the developing pole N1, so that the particles of the developer D lie in succession in the direction of the magnetic force. As a result, the developing pole N1 causes the developer D carried on the developing sleeve 41 to bristle and forms a magnetic brush.

Here, the toner contained in the developer D is charged negatively, and the carrier contained in the developer D is charged positively. Although the electrostatic latent image formed on the photoconductor 20 is charged negatively, the potential of the electrostatic latent image is higher than developing potential applied to the developing roller 40. Thus, the toner adheres to the photoconductor 20.

As a result, the electrostatic latent image formed on the photoconductor 20 is developed as the toner image. Then, the developer D remaining on the developing sleeve 41 is conveyed to the peeling pole S3. The developer D conveyed to the peeling pole S3 is peeled from the developing sleeve 41 because the magnetic field continues to weaken after the developer D passes the peeling pole S3.

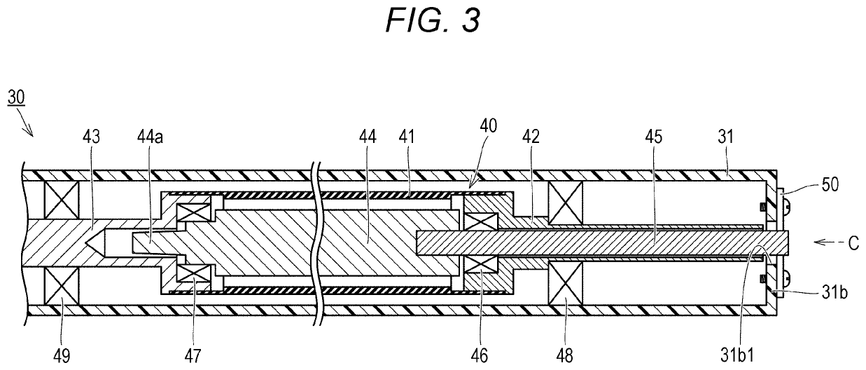

FIG. 3 is a schematic cross-sectional view illustrating a configuration of the developing roller illustrated in FIG. 2 and an assembly structure of the developing roller to the housing. Next, the detailed configuration of the developing roller 40 and the assembly structure of the developing roller 40 to the housing 31 will be described with reference to FIG. 3. Note that the cross section illustrated in FIG. 3 is a schematic cross section of the developing device 30 viewed along lines illustrated in FIG. 2.

As illustrated in FIG. 3, the developing roller 40 primarily includes; a rotating body including the developing sleeve 41 described above; a non-rotating body including the magnet part 44 described above; and bearings 46 and 47 that are set between the rotating body and the non-rotating body. Here, the non-rotating body is disposed substantially coaxially with the rotating body, inside the rotating body.

The rotating body includes; the developing sleeve 41; a first shaft member 42 fit and attached to one axial end of the developing sleeve 41; and a second shaft member 43 fit and attached to the other axial end of the developing sleeve 41. The non-rotating body includes the magnet part 44 and a rod 45 fastened to the magnet part 44, the rod 45 extending from one end in the extending direction of the axis of the magnet part 44. A rod-shaped protrusion 44a is provided at the other end of the magnet part 44, the protrusion 44a protruding from the other end, the other end being located opposite to the one end where the rod 45 is provided.

The bearing 46 lies between the first shaft member 42 and the rod 45, the outer ring of the bearing 46 being fastened to the first shaft member 42, the inner ring of the bearing 46 being fastened to the rod 45. The bearing 47 lies between the second shaft member 43 and the protrusion 44a of the magnet part 44, the outer ring of the bearing 47 being fastened to the second shaft member 43, the inner ring of the bearing 47 being fastened to the protrusion 44a.

The first shaft member 42 has a hollow, substantially cylindrical shape, and the rod 45 is inserted through a hollow portion of the first shaft member 42. With this arrangement, the leading end of the rod 45 is pulled out from the axial one end of the developing sleeve 41 via the hollow portion of the first shaft member 42, and the pulled-out portion of the rod 45 is fastened, via a holder 50 described later, to a sidewall 31b of the housing 31 as a fastening target.

Further, bearings 48 and 49 are set between the rotating body including the developing sleeve 41 and the housing 31. The bearing 48 lies between the housing 31 and the first shaft member 42, the outer ring of the bearing 48 being fastened to the housing 31, the inner ring of the bearing 48 being fastened to the first shaft member 42. The bearing 49 lies between the housing 31 and the second shaft member 43, the outer ring of the bearing 49 being fastened to the housing 31, the inner ring of the bearing 49 being fastened to the second shaft member 43.

With this arrangement, as will be described later in details, the non-rotating body including the magnet part 44 is unrotatably and unmovably fastened to the housing 31, whereas the rotating body including the developing sleeve 41 is rotatably supported by the non-rotating body including the magnet part 44 via the bearings 46 and 47, and rotatably supported by the housing 31 via the bearings 48 and 49.

Here, the sidewall 31b of the housing 31 has an opening 31b1 provided in the sidewall 31b. The leading end of the portion of the rod 45 pulled out from the above-described first shaft member 42 is located protruding outside the housing 31 via the opening 31b1. The holder 50 is fit and fastened to the outer front face of the sidewall 31b of the housing 31 while holding the portion of the rod 45 protruding outside the housing 31.

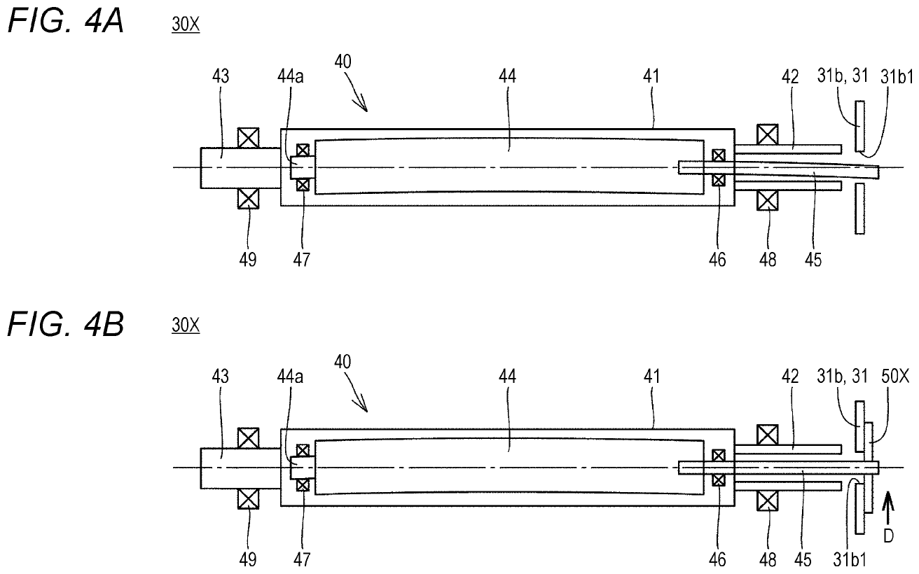

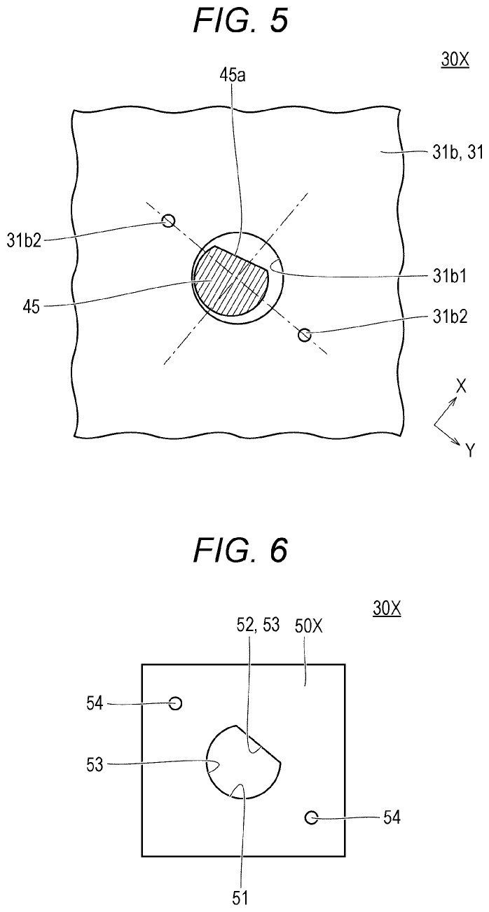

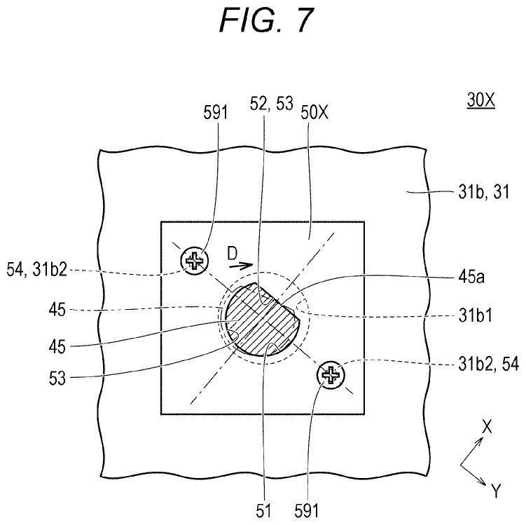

FIGS. 4A and 4B are schematic views for explaining the concept of a magnet part fastening method according to a conventional example. FIG. 5 is a view illustrating an example of a provision position of a rod in a non-fastened state in a case where the magnet part fastening method according to the conventional example is adopted. FIG. 6 is a view illustrating a shape of a holder according to the conventional example. FIG. 7 is a view illustrating a fastened state of the rod according to the conventional example. Next, prior to explaining the magnet part fastening method according to the present embodiment, the magnet part fastening method according to the typical conventional example is described with reference to FIGS. 4A and 4B to FIG. 7. Note that FIGS. 5 and 7 are views of a developing device 30X according to the conventional example, viewed along the direction of an arrow C illustrated in FIG. 3. In order to facilitate the understanding, a rod 45 is hatched.

As described above, in the developing device, the magnet part is affected by the magnetic body located on the periphery of the magnet part, due to the magnetic attraction force of the magnet part itself. As a result, the magnet part and the rod warp unintentionally. Further, as described above, due to the finished quality of the magnet part and the rod at manufacturing stage thereof, a considerable degree of variation in dimensional accuracy occurs. Therefore, while the developing roller is assembled to the housing, in the state before the rod is fastened to the housing by using the holder, the axis of the rod is not disposed at the nominal center position of the rod, normally. As a result, the axis of the rod is disposed positionally deviating from the nominal center position.

FIG. 4A illustrates the rod 45 at which positional deviation has occurred, in the developing device 30X according to the conventional example. That is, in a non-fastened state before the rod 45 is fastened to a sidewall 31b of a housing 31 by a holder 50X (see FIG. 4B), warps at a magnet part 44 and the rod 45 due to magnetic attraction force described above in combination with variation in dimensional accuracy due the finished quality described above result in occurrence of positional deviation from the nominal center position at the rod 45.

As illustrated in FIG. 4B, in the case of the developing device 30X according to the conventional example, the holder 50X is attached to the rod 45, and the holder 50X is fastened to the sidewall 31b of the housing 31 at a predetermined position. With this arrangement, as the rod 45 rotates, the rod 45 moves in the direction of an arrow D illustrated in the figure, and the rod 45 is disposed such that the axis of the rod 45 overlaps the nominal center position. As a result, the positional deviation of the rod 45 is corrected forcibly.

More specifically, as illustrated in FIG. 5, in the developing device 30X according to the conventional example, an opening 31b1 is provided at a position corresponding to the above-described nominal center position of the sidewall 31b of the housing 31. The opening 31b1 is formed sufficiently larger than the outer shape of the rod 45. At predetermined positions on the periphery of the opening 31b1, provided is a pair of screw holes 31b2.

On the other hand, the rod 45 has a substantially columnar shape, the rod 45 having a flat contact-stopping face 45a provided on a portion of the circumferential face of the rod 45 where the holder 50X is attached. That is, the portion of the rod 45 where the holder 50X is attached has a substantially D shape in cross-sectional view. In the non-fastened state, the rod 45 is inserted into the opening 31b1, so that the rod 45 is located inside the opening 31b1. Note that, at this time, the above-described positional deviation has occurred at the rod 45.

As illustrated in FIG. 6, the holder 50X is formed of a metal plate-like member having a rectangular shape in plan view. The holder 50X has an engaging hole 51 having a through-hole shape, the engaging hole 51 being provided at a predetermined position of the holder 50X. The engaging hole 51 is formed in the same shape as the outer shape of the rod 45 described above, and has a substantially D shape in plan view. The engaging hole 51 is formed to be equal to or slightly larger than the size of the rod 45. At predetermined positions on the periphery of the engaging hole 51, a pair of insertion holes 54 is provided, each insertion hole 54 having a through-hole shape. The pair of insertion holes 54 is substantially similar in size and shape to the pair of screw holes 31b2 described above.

Here, the engaging hole 51 and the pair of insertion holes 54 provided in the holder 50X are at positions corresponding to the opening 31b1 and the pair of screw holes 31b2 provided in the sidewall 31b of the housing 31, respectively. That is, when the holder 50X is fit to the outer front face of the sidewall 31b of the housing 31 such that the pair of insertion holes 54 overlaps the pair of screw holes 31b2, the engaging hole 51 overlaps the nominal center position of the rod 45 described above.

Therefore, as illustrated in FIG. 7, in the fastened state, the holder 50X is attached to the rod 45, and then the holder 50X is fastened to the sidewall 31b of the housing 31 with a pair of screws 591. As a result, the rod 45 is disposed such that the axis of the rod 45 agrees with the nominal center position. That is, the pair of screws 591 is screwed into the pair of screw holes 31b2 provided in the sidewall 31b of the housing 31, while the pair of screws 591 is inserted through the pair of insertion holes 54 provided in the holder 50X. As a result, the rod 45 is forcibly rotated by the holder 50X and moved in the direction of an arrow D illustrated in the figure, and the axis of the rod 45 is disposed at the nominal center position.

Here, of portions of the holder 50X that define the engaging hole 51, a portion having a linear shape in plan view is in contact with the contact-stopping face 45a of the rod 45 in the fastened state. As a result, the portion functions as a rotation preventer 52 that prevents rotation of the rod 45.

Further, of the portions of the holder 50X that define the engaging hole 51, a portion having a curved shape in plan view and the above-described portion having a linear shape in plan view is in contact with the rod 45 in the fastened state such that the rod 45 is interposed therebetween. As a result, the portions function as a movement preventer 53 that prevents movement of the rod 45. That is, in the conventional example, all the portions of the holder 50X that define the engaging hole 51 function as the movement preventer 53.

Therefore, in the case of the developing device 30X according to the conventional example described above, by using the holder 50X, the rod 45 is adjusted in regulation angle and the rotation and movement of the rod 45 are regulated in the fastened state, whereas the rod 45 is forcibly disposed at the nominal center position. Thus, the forcible disposition may result in occurrence of unnatural warps on the magnet part 44 and the rod 45 of which the warps are natural warp unnaturally.

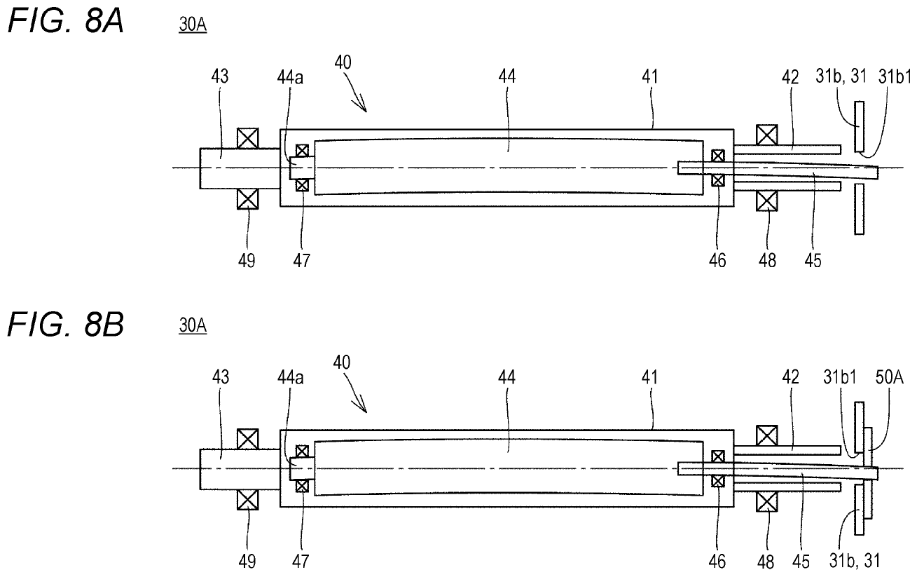

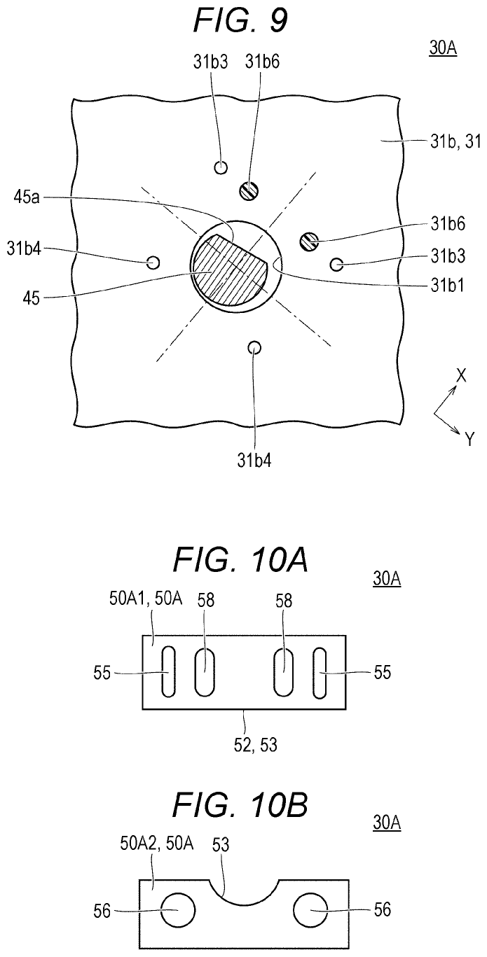

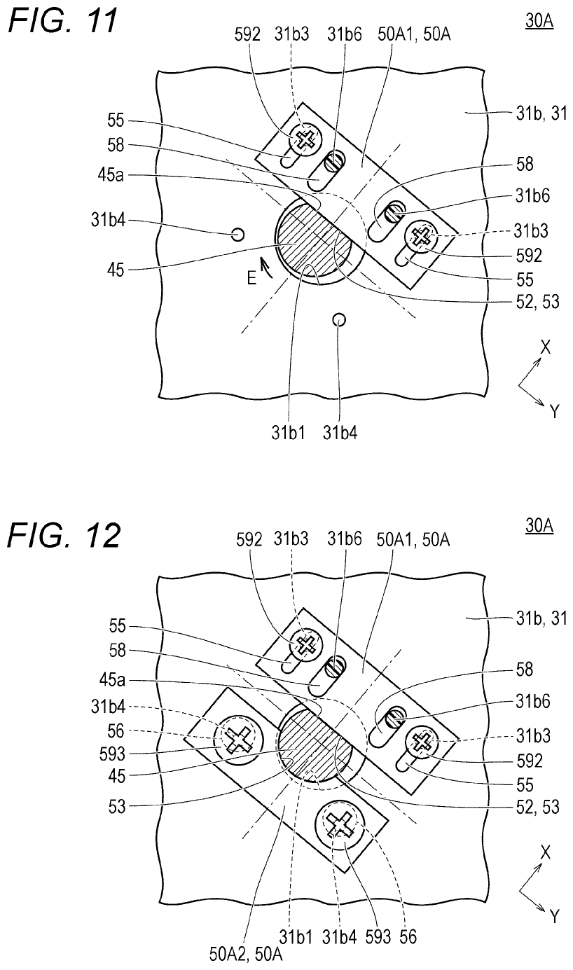

FIGS. 8A and 8B are schematic views for explaining the concept of a magnet part fastening method according to a first configuration example based on the present embodiment. FIG. 9 is a view illustrating an example of a provision position of a rod in a non-fastened state in a case where the magnet part fastening method according to the first configuration example is adopted. FIGS. 10A and 10B are views illustrating a shape of a holder according to the first configuration example. FIG. 11 is a view illustrating a temporarily fastened state of the rod and FIG. 12 is view illustrating a fastened state of the rod, according to the first configuration example. Next, the magnet part fastening method according to the first configuration example based on the present embodiment will be described with reference to FIGS. 8A and 8B to FIG. 12. Note that FIGS. 9, 11 and 12 are views of a developing device 30A according to the first configuration example, viewed along the direction of the arrow C illustrated in FIG. 3. In order to facilitate the understanding, a rod 45 and a pair of guide projections 31b6 described later are hatched.

FIG. 8A illustrates a non-fastened state before a holder 50A (see FIG. 8B) described later is attached to the rod 45 and fastened to a sidewall 31b of a housing 31 in the developing device 30A according to the present configuration example. In the non-fastened state, the positional deviation described above has occurred at the rod 45.

As illustrated in FIG. 8B, in the case of the developing device 30A according to the present configuration example, the holder 50A described later is attached to the rod 45 and fastened to the sidewall 31b of the housing 31. As a result, the provision angle of the rod 45 is adjusted to agree with a regulation angle, and the rod 45 is fastened at a provision position after the rod 45 is adjusted in regulation angle while the positional deviation from the nominal center position has still occurred. That is, the rod fastening method according to the present configuration example is different from the rod fastening method according to the above-described conventional example. Thus, with this method, forcible agreement of the axis of the rod 45 with the nominal center position is not made.

At that time, the holder 50A is adjusted in fastening position to the sidewall 31b of the housing 31 in the in-plane direction of a plane substantially orthogonal to the axis of the rod 45. With this adjustment, the rod 45 after the provision angle thereof is adjusted in regulation angle within a predetermined range in the in-plane direction is held by the holder 50A while being disposed at the position.

More specifically, as illustrated in FIG. 9, in the developing device 30A according to the present configuration example, an opening 31b1 is provided at a position corresponding to the above-described nominal center position of the sidewall 31b of the housing 31. The opening 31b1 is formed sufficiently larger than the outer shape of the rod 45. At predetermined positions on the periphery of the opening 31b1, provided are a pair of first screw holes 31b3, a pair of second screw holes 31b4, and a pair of guide projections 31b6. The pair of guide projections 31b6 guides a first member 50A1 described later along a predetermined direction at the time of assembly, each guide projection 31b6 protruding outward from the outer front face of the sidewall 31b.

On the other hand, the rod 45 has a substantially columnar shape, the rod 45 having a flat contact-stopping face 45a provided on a portion of the circumferential face of the rod 45 where the holder 50A is attached. That is, the portion of the rod 45 where the holder 50A is attached has a substantially D shape in cross-sectional view. In the non-fastened state, the rod 45 is inserted into the opening 31b1, so that the rod 45 is located inside the opening 31b1. Note that, at this time, the above-described positional deviation has occurred at the rod 45.

As illustrated in FIGS. 10A and 10B, the holder 50A includes a first member 50A1 and a second member 50A2, each of the first member 50A1 and the second member 50A2 having a different rectangular shape in plan view. Each of the first member 50A1 and the second member 50A2 is formed of a metal plate-like member. The first member 50A1 is provided with a pair of first insertion holes 55 and a pair of guide holes 58, each of the first insertion holes 55 and the guide holes 58 having a through-hole shape, at predetermined positions of the first member 50A1. The second member 50A2 is provided with a pair of second insertion holes 56, each second insertion hole 56 having a through-hole shape, at a predetermined position of the second member 50A2.

Here, each of the first insertion holes 55 provided in the first member 50A1 has a slotted-hole shape in plan view. The widths in the minor axis direction of the pair of first insertion holes 55 are substantially similar to the diameters of the pair of first screw holes 31b3 provided in the sidewall 31b of the housing 31 described above. Each of the pair of guide holes 58 provided in the first member 50A1 has a slotted-hole shape in plan view. The widths in the minor axis direction of the pair of guide holes 58 are substantially similar to the widths of the pair of guide projections 31b6 provided on the sidewall 31b of the housing 31 described above. Note that the pair of first insertion holes 55 and the pair of guide holes 58, each of the first insertion holes 55 and the guide holes 58 having a slotted-hole shape in plan view, extend in parallel with each other.

Each of the pair of second insertion holes 56 provided in the second member 50A2 has a circular shape in plan view. The pair of second insertion holes 56 is sufficiently larger in size than the pair of second screw holes 31b4 provided in the sidewall 31b of the housing 31 described above.

The pair of first insertion holes 55 and the pair of guide holes 58 provided in the first member 50A1 are at positions corresponding to the pair of first screw holes 31b3 and the pair of guide projections 31b6 provided in the sidewall 31b of the housing 31, respectively. Each of the pair of second insertion holes 56 provided in the second member 50A2 is at a position corresponding to each of the pair of second screw holes 31b4 provided in the sidewall 31b of the housing 31.

Here, the first member 50A1 is provided with a rotation preventer 52 having a linear shape in plan view. The rotation preventer 52 is defined at one side of the first member 50A1 having a rectangular shape in plan view. The extending direction of the rotation preventer 52 is orthogonal to each extending direction of the pair of first insertion holes 55 and the pair of guide holes 58 provided in the first member 50A1, each of the first insertion holes 55 and the guide holes 58 having a slotted-hole shape in plan view described above. Note that the rotation preventer 52 is larger in width than the contact-stopping face 45a of the rod 45.

The second member 50A2 is provided with a movement preventer 53 having a curved shape in plan view. The movement preventer 53 is formed by providing a curved cut-away portion on one side of the first member 50A1 having a rectangular shape in plan view. Here, the movement preventer 53 has a shape along a portion of the circumferential face of the rod 45, the portion excluding the contact-stopping face 45a of the rod 45.

As illustrated in FIGS. 11 and 12, when the holder 50A is attached to the rod 45 and fastened to the sidewall 31b of the housing 31, first, the rod 45 is temporarily fastened by using the first member 50A1, and then the rod 45 is fastened by using the second member 50A2.

Specifically, first, as illustrated in FIG. 11, the rod 45 is rotated such that the provision angle of the rod 45 in the non-fastened state agrees with the predetermined regulation angle, and then the first member 50A1 is fit to the rod 45 and the sidewall 31b of the housing 31 such that the provision position of the rod 45 at which the provision angle agrees with the regulation angle is maintained as it is. At that time, before the first member 50A1 is fit to the rod 45 and the sidewall 31b, the rod 45 may be rotated such that the provision angle of the rod 45 roughly agrees with the regulation angle in advance.

At this time, the pair of guide projections 31b6 provided on the sidewall 31b is inserted into the pair of guide holes 58 provided in the first member 50A1. As a result, the first member 50A1 is guided along the direction of an arrow X illustrated in the figure. Therefore, the first member 50A1 is moved in the direction of the arrow X while the first member 50A1 is fit to the outer front face of the sidewall 31b, so that the first member 50A1 can be fit to the contact-stopping face 45a of the rod 45 and the sidewall 31b of the housing 31 without applying a large load to the rod 45.

Here, in the non-fastened state, the above-described rotation preventer 52 is brought into contact with the contact-stopping face 45a of the rod 45. That is, in the non-fastened state, the rotation preventer 52 in contact with the contact-stopping face 45a of the rod 45 rotates the rod 45 (in the present example, the rotation direction is indicated by the direction of an arrow E illustrated in the figure), and thus the provision angle of the rod 45 is adjusted to agree with the regulation angle.

Further, at this time, the pair of guide holes 58 provided in the first member 50A1 is inserted into the pair of guide projections 31b6 provided on the sidewall 31b. Thus, the rotation preventer 52 is disposed so as to agree with an angle to be formed by the contact-stopping face 45a of the rod 45 disposed at the regulation angle. That is, the pair of guide projections 31b6 is provided so as to be able to guide the first member 50A1 along a direction orthogonal to the contact-stopping face 45a in the fastened state. Therefore, as described above, the contact-stopping face 45a and the rotation preventer 52 are in contact with each other, so that the provision angle of the rod 45 is adjusted to agree with the regulation angle.

Next, the first member 50A1 is fastened to the sidewall 31b of the housing 31 with a pair of first screws 592. At that time, the pair of first screw holes 31b3 provided in the sidewall 31b overlaps part of the pair of first insertion holes 55 provided in the first member 50A1, each first insertion hole 55 having a slotted-hole shape in plan view. Thus, fastening of the first member 50A1 with the pair of first screws 592 can be made easily.

Subsequently, as illustrated in FIG. 12, the second member 50A2 is fit to the rod 45 and the sidewall 31b of the housing 31 such that the provision position of the rod 45 is maintained as it is after the provision angle is adjusted to agree with the regulation angle by the first member 50A1, and then the second member 50A2 is fastened to the sidewall 31b of the housing 31 with a pair of second screws 593.

At that time, the second member 50A2 is disposed such that the movement preventer 53 provided on the second member 50A2 is fit along a portion of the circumferential face of the rod 45, the portion excluding the contact-stopping face 45a of the rod 45, and such that the pair of second insertion holes 56 provided in the second member 50A2 overlaps the pair of second screw holes 31b4 provided on the sidewall 31b. While the state is maintained, the second member 50A2 is fastened to the sidewall 31b of the housing 31 with the pair of second screws 593.

At this time, as described above, the pair of second insertion holes 56 is sufficiently larger than the pair of second screw holes 31b4, so that rough positioning of the second member 50A2 causes the pair of second insertion holes 56 and the pair of second screw holes 31b4 to overlap with each other. Further, as illustrated in the figure, the pair of second screws 593 is used, each second screw 593 having a sufficiently large screw head, so that the second member 50A2 of which the rough positioning is made can be fastened at the position.

As described above, in the fastened state, the rotation preventer 52 provided on the first member 50A1 is in contact with the contact-stopping face 45a of the rod 45, and the movement preventer 53 provided on the second member 50A2 is in fit and contact with the rod 45. Further, the rod 45 is also interposed between the rotation preventer 52 provided on the first member 50A1 and the movement preventer 53 provided on the second member 50A2.

With this arrangement, by using the holder 50A having the above-described configuration, the provision angle of the rod 45 in the non-fastened state can be adjusted to agree with the predetermined regulation angle, and the rod 45 can be fastened to the sidewall 31b of the housing 31 while the provision position of the rod 45 after the provision angle agrees with the regulation angle is maintained as it is. As a result, rotation and movement of the rod 45 can be both regulated in the fastened state.

Therefore, by adopting the configuration as in the first configuration example, the respective angles of the magnet part 44 and the rod 45 can be adjusted in regulation angle, and the magnet part 44 and the rod 45 of which warps are natural can be fastened as the warps are natural. As a result, the magnet part 44 and the rod 45 can be held and fastened in a substantially unloaded state without occurrence of unnatural warps. Therefore, smooth rotation of the developing sleeve 41 is achievable, and as a result, occurrence of disturbance or noise in a formed image is preventative in advance.

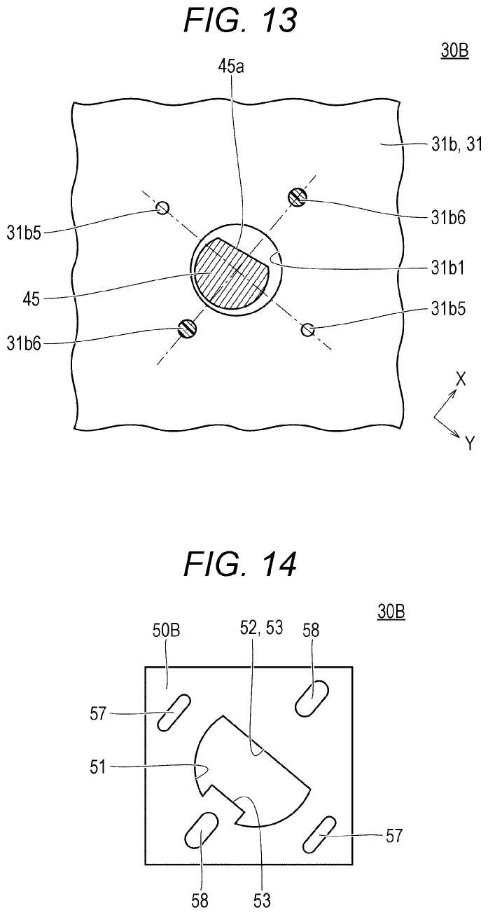

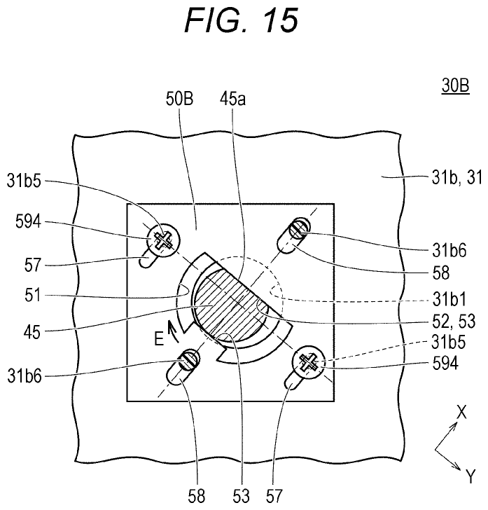

FIG. 13 is a view illustrating an example of a provision position of a rod in a non-fastened state in a case where a magnet part fastening method according to a second configuration example based on the present embodiment is adopted. FIG. 14 is a view illustrating a shape of a holder according to the second configuration example. FIG. 15 is a view illustrating a fastened state of a rod according to the second configuration example. Next, the magnet part fastening method according to the second configuration example based on the present embodiment will be described with reference to FIGS. 13 to 15. Note that FIGS. 13 and 15 are views of a developing device 30B according to the second configuration example, viewed along the direction of the arrow C illustrated in FIG. 3. In order to facilitate the understanding, a rod 45 and a pair of guide projections 31b6 are hatched.

In the case of the developing device 30B according to the present configuration example, similarly to the developing device 30A according to the above-described first configuration example, a holder 50B described later is attached to the rod 45 and fastened to a sidewall 31b of a housing 31. As a result, the provision angle of the rod 45 is adjusted to agree with a regulation angle, and the rod 45 is fastened at a provision position after the rod 45 is adjusted in regulation angle while positional deviation from the nominal center position has still occurred. That is, similarly to the developing device 30A according to the above-described first configuration example, a rod fastening method according to the present configuration example is different from the rod fastening method according to the above-described conventional example. Thus, with the method according to the present configuration example, forcible arrangement of the axis of the rod 45 with the nominal center position is not made.

More specifically, as illustrated in FIG. 13, in the developing device 30B according to the present configuration example, an opening 31b1 is provided at a position corresponding to the above-described nominal center position of the sidewall 31b of the housing 31. The opening 31b1 is formed sufficiently larger than the outer shape of the rod 45. At predetermined positions on the periphery of the opening 31b1, provided are a pair of screw holes 31b5 and a pair of guide projections 31b6. The pair of guide projections 31b6 guides the holder 50B described later along a predetermined direction at the time of assembly, each guide projection 31b6 protruding outward from the outer front face of the sidewall 31b. Here, the protrusion amount of each guide projection 31b6 is sufficiently larger than the protrusion amount of the rod 45 from the sidewall 31b.

On the other hand, the rod 45 has a substantially columnar shape, the rod 45 having a flat contact-stopping face 45a provided on a portion of the circumferential face of the rod 45 where the holder 50B is attached. That is, the portion of the rod 45 where the holder 50B is attached has a substantially D shape in cross-sectional view. In a non-fastened state, the rod 45 is inserted into the opening 31b1, so that the rod 45 is located inside the opening 31b1. Note that, at this time, the above-described positional deviation has occurred at the rod 45.

As illustrated in FIG. 14, the holder 50B is formed of a single metal plate-like member having a rectangular shape in plan view, and an engaging hole 51 having a through-hole shape is provided at a predetermined position of the holder 50B. Although the engaging hole 51 has a substantially D shape in plan view similarly to the outer shape of the rod 45 described above, the shape is different in details. The engaging hole 51 is formed sufficiently larger in the predetermined direction than the size of the rod 45. At predetermined positions on the periphery of the engaging hole 51, provided are a pair of insertion holes 57 and a pair of guide holes 58, each of the insertion holes 57 and the guide holes 58 having a through-hole shape.

Here, of portions of the holder 50B that define the engaging hole 51, a portion having a linear shape in plan view and the longest width is in contact with a contact-stopping face 45a of the rod 45 in the fastened state. As a result, the portion functions as a rotation preventer 52 that prevents rotation of the rod 45.

Further, of the portions of the holder 50B that define the engaging hole 51, the above-described portion having a linear shape in plan view and the longest width and a portion located opposite to the above-described portion and having a linear shape in plan view are in contact with the rod 45 in the fastened state such that the rod 45 is interposed therebetween. As a result, the portions each function as a movement preventer 53 that prevents movement of the rod 45. Note that the distance between the movement preventers 53 disposed opposite to each other is set slightly smaller than the maximum thickness of a portion where the contact-stopping face 45a of the rod 45 is provided, in a direction orthogonal to the contact-stopping face 45a.

Each of the pair of insertion holes 57 has a slotted-hole shape in plan view. The widths in the minor axis direction of the pair of insertion holes 57 are substantially similar to the diameters of the pair of screw holes 31b5 provided in the sidewall 31b of the housing 31 described above. Each of the pair of guide holes 58 has a slotted-hole shape in plan view. The widths in the minor axis direction of the pair of guide holes 58 are substantially similar to the widths of the pair of guide projections 31b6 provided on the sidewall 31b of the housing 31 described above. Note that the pair of insertion holes 57 and the pair of guide holes 58, each of the insertion holes 57 and the guide holes 58 having a slotted-hole shape in plan view, extend in parallel with each other.

The pair of insertion holes 57 and the pair of guide holes 58 are provided at positions corresponding to the pair of screw holes 31b5 and the pair of guide projections 31b6 provided on the sidewall 31b of the housing 31, respectively.

As illustrated in FIG. 13, when the holder 50B is attached to the rod 45 and fastened to the sidewall 31b of the housing 31, first, the rod 45 is rotated such that the provision angle of the rod 45 in the non-fastened state agrees with a predetermined regulation angle, and then the holder 50B is fit to the rod 45 and the sidewall 31b of the housing 31 such that the provision position of the rod 45 at which the provision angle agrees with the regulation angle is maintained as it is. At that time, before the holder 50B is fit to the rod 45 and the sidewall 31b, the rod 45 may be rotated such that the provision angle of the rod 45 roughly agrees with the regulation angle in advance.

At this time, the pair of guide projections 31b6 provided on the sidewall 31b is inserted into the pair of guide holes 58 provided on the holder 50B, so that the holder 50B is guided along the direction of an arrow X illustrated in the figure (at this time of point, the rod 45 has not yet been inserted into the engaging hole 51). Therefore, the holder 50B can be moved in the direction of the arrow X.

Next, the holder 50B is moved toward the sidewall 31b. The position of the holder 50B is adjusted along the direction of an arrow Y, and the rod 45 is rotated so as to be insertable into the engaging hole 51 (in the present example, this rotation direction is indicated by the direction of an arrow E illustrated in the figure). Then, the rod 45 is inserted into the engaging hole 51, and the holder 50B is fit to the sidewall 31b. At this time, as described above, the distance between the movement preventers 53 disposed opposite to each other is slightly smaller than the above-described maximum thickness of the rod 45. Thus, the rod 45 is press inserted into the engaging hole 51.

Here, the above-described rotation preventer 52 is brought into contact with the contact-stopping face 45a of the rod 45. That is, the rotation preventer 52 is in contact with the contact-stopping face 45a of the rod 45 by rotating the rod 45. As a result, the provision angle of the rod 45 is adjusted to agree with the regulation angle.

Further, at this time, the pair of guide holes 58 provided in the holder 50B is inserted into the pair of guide projections 31b6 provided on the sidewall 31b. Thus, the rotation preventer 52 is disposed so as to agree with an angle to be formed by the contact-stopping face 45a of the rod 45 disposed at the regulation angle. That is, the pair of guide projections 31b6 is provided so as to be able to guide the holder 50B along a direction orthogonal to the contact-stopping face 45a in the fastened state. Therefore, as described above, the contact-stopping face 45a and the rotation preventer 52 are in contact with each other, so that the provision angle of the rod 45 is adjusted to agree with the regulation angle.

Subsequently, the holder 50B is fastened to the sidewall 31b of the housing 31 by using a pair of screws 594. At this time, the pair of screw holes 31b5 provided in the sidewall 31b overlaps part of the pair of insertion holes 57 provided in the holder 50B, each insertion hole 57 having a slotted-hole shape in plan view. Thus, fastening of the holder 50B by using the pair of screws 594 can be made easily.

As described above, in the fastened state, the rotation preventer 52 is in contact with the contact-stopping face 45a of the rod 45, and the rotation preventer 52 and the movement preventer 53 are in contact with the rod 45 such that the rod 45 is interposed between the rotation preventer 52 and the movement preventer 53.

With this arrangement, by using the holder 50B having the above-described configuration, the provision angle of the rod 45 in the non-fastened state can be adjusted to agree with the predetermined regulation angle, and the rod 45 can be fastened to the sidewall 31b of the housing 31 while the provision position of the rod 45 after the provision angle agrees with the regulation angle is maintained as it is. As a result, rotation and movement of the rod 45 can be both regulated in the fastened state.

Therefore, by adopting the configuration as in the second configuration example, the respective angles of the magnet part 44 and the rod 45 can be adjusted in regulation angle, and the magnet part 44 and the rod 45 of which warps are natural can be fastened as the warps are natural. As a result, the magnet part 44 and the rod 45 can be held and fastened in a substantially unloaded state without occurrence of unnatural warps. Therefore, smooth rotation of the developing sleeve 41 is achievable, and as a result, occurrence of disturbance or noise in a formed image is preventative in advance.

The holders according to the first configuration example and the second configuration example based on the embodiment of the present invention described above are merely exemplified as a holder that is adjusted in fastening position to a fastening target and the adjustment of the holder enables disposition and holding of the rod at an optional position within a predetermined range. That is, the configuration of the holder is not limited to these configuration examples, and various modifications may be made.

Further, in the above-described embodiment of the present invention, the description has been made by exemplifying the case where the present invention is applied to a so-called tandem color printer adopting an electrophotographic method and a developing device included in the tandem color printer. However, the application target of the present invention is not limited to the tandem color printer and the developing device included therein, and the present invention is applicable to various image forming apparatuses adopting an electrophotographic method and developing devices included in the image forming apparatuses.

Although embodiments of the present invention have been described and illustrated in detail, the disclosed embodiments are made for purposes of illustration and example only and not limitation. The scope of the present invention should be interpreted by terms of the appended claims, and includes all modifications within the scope and meaning equivalent to the description of the accompanying claims

What is claimed is:

1. A developing device, comprising:
a developing sleeve supported rotatably, the developing sleeve having a hollow, substantially cylindrical shape;
a magnet part having a substantially columnar shape, the magnet part having a plurality of magnetic poles disposed side by side around an axis, the magnet part being disposed substantially coaxially with the developing sleeve inside the developing sleeve;
a rod fastened to the magnet part, the rod extending from one end in an extending direction of the axis of the magnet part, the rod being pulled out from one axial end of the developing sleeve; and
a holder attached to a portion of the rod pulled out from the developing sleeve, the holder being fastened to a fastening target, the holder maintaining the rod, the holder regulating rotation of the magnet part,
wherein adjustment of the holder in fastening position to the fastening target enables disposition and holding of the rod at an optional position within a predetermined range in an in-plane direction of a plane orthogonal to the axis, and
in a case where a state before the holder is attached to the rod and fastened to the fastening target is defined as a non-fastened state, after the rod is rotated such that a provision angle of the rod in a circumferential direction of the rod in the non-fastened state agrees with a predetermined regulation angle, the holder is attached to the rod and fastened to the fastening target such that a provision position of the rod at which the provision angle agrees with the regulation angle is maintained as the provision position is.

2. The developing device according to claim 1,
wherein the rod has a flat contact-stopping face provided on a circumferential face of the rod, the rod having a substantially columnar shape, and
the holder includes a rotation preventer and a movement preventer, in a case where a state in which the holder is attached to the rod and fastened to the fastening target is defined as a fastened state, in the non-fastened state, the rotation preventer in contact with the contact-stopping face rotates the rod, in the fastened state, the rotation preventer in contact with the contact-stopping face prevents rotation of the rod, and in the fastened state, the movement preventer in fit and contact with the rod prevents movement of the rod.

3. The developing device according to claim 2,
wherein in the in-plane direction, the rotation preventer is larger in width than the contact-stopping face.

4. The developing device according to claim 2,
wherein the holder includes a first member having the rotation preventer and a second member having the movement preventer, and
the first member is fastened to the fastening target with the rotation preventer in contact with the contact-stopping face, and the second member is fastened to the fastening target with the movement preventer in fit and contact with the rod.

5. The developing device according to claim 4,
wherein the movement preventer has a curved shape along at least part of a portion of the circumferential face of the rod, the portion excluding the contact-stopping face of the rod.

6. The developing device according to claim 4,
wherein the rod is further interposed between the rotation preventer and the movement preventer.

7. The developing device according to claim 4,
wherein the fastening target is provided with a guide capable of guiding the first member along a direction orthogonal to the contact-stopping face in the fastened state, in the in-plane direction.

8. The developing device according to claim 2,
wherein the holder is formed of a single member having the rotation preventer and the movement preventer, and
the rod is interposed between the rotation preventer and the movement preventer.

9. The developing device according to claim 8,
wherein the fastening target is provided with a guide capable of guiding the holder along a direction orthogonal to the contact-stopping face in the fastened state, in the in-plane direction.

10. An image forming apparatus, comprising: the developing device according to claim 1 with which the image forming apparatus forms an image.
